(19) United States
(12) Patent Application Publication
(10) Pub. No.: US 2026/0353110 A1
(43) Pub. Date: Nov. 5, 2026

(54) METHODS, CIRCUITS, DEVICES AND SYSTEMS FOR ADAPTIVE KNOWLEDGE TRANSFER IN COMMUNICATION NETWORKS

(71) Applicant: Huawei Technologies Co., Ltd., Shenzhen (CN)

(72) Inventors: Yasser Khalil, Ottawa (CA); Xi Chen, Markham (CA); Sobhan Hemati, Ottawa (CA); Xu Li, Nepean (CA)

(21) Appl. No.: 19/718,622

(22) Filed: Jun. 24, 2026

Related U.S. Application Data
(63) Continuation of application No. PCT/CN2024/070436, filed on Jan. 3, 2024.

(51) Int. Cl. H04W 24/02; H04L 41/16; H04W 84/06

(52) U.S. Cl. CPC H04W 24/02; H04L 41/16; H04W 84/06

(57) ABSTRACT

The present disclosure relates to methods, circuits, devices and systems for adaptive knowledge transfer. In an example method, a device receives a set of training parameters comprising a current training iteration number and an exploitation/exploration ratio, receives a training model, performs training on the training model using the exploitation/exploration ratio to obtain a trained model, updates a peak model with the trained model, and sends the trained model. In another example method, an aggregating device receives one or more trained models, performs averaging and distilling of the one or more trained models to obtain a new iteration model, and transmits the new iteration model and an exploitation/exploration ratio.

### CROSS-REFERENCE TO RELATED APPLICATION

This application is a continuation of International Application No. PCT/CN2024/070436, filed on Jan. 3, 2024, the disclosure of which is hereby incorporated by reference in its entirety.

### TECHNICAL FIELD

The present disclosure relates generally to methods, circuits, devices and systems for communications systems, in particular for adaptive knowledge transfer in communications networks.

### BACKGROUND

Decentralized Federated Learning (DFL) is a standard baseline approach for machine learning devices to learn from decentralized data. Learning from decentralized data contributes to preventing privacy leakage over centralized data. Two widely used federated learning aggregation techniques are weight-space aggregation and output-space aggregation. A disadvantage of weight-space aggregation methods is that models used therein must be homogeneous and a central server may be required. An example of weight-space aggregation is FedAvg. An additional downside of FedAvg is that its communication cost is high.

In contrast, output-space aggregation techniques such as knowledge distillation do not require a server and models may be heterogeneous. Mutual Knowledge Distillation (Mutual KD) is a method that uses knowledge distillation.

No method has been proposed for Mutual KD in a decentralized federated learning environment that fully supports heterogenous settings.

### SUMMARY

In some embodiments disclosed herein, methods comprise an adaptive methodology for enhancing convergence speed which may be equivalent to reducing communication cost, and increasing final global accuracy. An adaptive KD method may comprise adapting the exploitation and exploration ratio represented by CE and KLD in knowledge distillation loss function.

In a broad aspect of the present disclosure, a method comprises: receiving a set of training parameters comprising a current training iteration number and an exploitation/exploration ratio; receiving a training model for the current training iteration number; performing training on the training model using the exploitation/exploration ratio to obtain a trained model; updating a peak model with the trained model based at least partly on the exploitation/exploration ratio comprising greater exploration than an exploitation/exploration ratio associated with a current peak model; and sending the trained model.

In some embodiments, the exploitation/exploration ratio comprises an exploitation value and an exploration value and the exploitation value and the exploration value sum to one.

In some embodiments, the exploitation value and the exploration value oscillate between zero and one.

In some embodiments, the set of training parameters further comprises a temperature, an optimizer learning rate, a momentum, a weight decay, and a loss for training.

In some embodiments, the set of training parameters further comprises a time window for completing training for the current training iteration number.

In some embodiments, one or more circuits of a device can be configured to perform the method.

In a broad aspect of the present disclosure, a method comprises: receiving one or more trained models for a current training iteration number; performing averaging and distilling of the one or more trained models to obtain a new iteration model; and transmitting the new iteration model and an exploitation/exploration ratio.

In some embodiments, the method further comprises receiving a set of training parameters comprising the current training iteration number and the exploitation/exploration ratio.

In some embodiments, receiving a set of training parameters comprises receiving a set of training parameters from an orchestrating device.

In some embodiments, the method further comprises sending an iteration complete signal to the orchestrating device.

In some embodiments, the exploitation/exploration ratio comprises an exploitation value and an exploration value and the exploitation value and the exploration value sum to one.

In some embodiments, the exploitation value and the exploration value oscillate between zero and one.

In some embodiments, the set of training parameters further comprises a temperature, an optimizer learning rate, a momentum, a weight decay, and a loss for training.

In some embodiments, the set of training parameters further comprises a time window for completing training for the current training iteration number.

In some embodiments, one or more circuits of a device can be configured to perform the method.

In a broad aspect of the present disclosure, a method comprises: transmitting a set of training parameters comprising a current training iteration number and the exploitation/exploration ratio; determining a new exploitation/exploration ratio and new iteration number; and transmitting a new exploitation/exploration ratio and new iteration number.

In some embodiments, the method further comprises receiving an iteration complete signal.

In some embodiments, the exploitation/exploration ratio comprises an exploitation value and an exploration value and the exploitation value and the exploration value sum to one.

In some embodiments, the exploitation value and the exploration value oscillate between zero and one.

In some embodiments, the set of training parameters further comprises a temperature, an optimizer learning rate, a momentum, a weight decay, and a loss for training.

In some embodiments, the set of training parameters further comprises a time window for completing training for the current training iteration number.

In some embodiments, one or more circuits of a device can be configured to perform the method.

In a broad aspect of the present disclosure, a method comprises: performing training on one or more training models using an exploitation/exploration ratio to obtain one or more trained models; performing averaging and distilling of the one or more trained models to obtain a new iteration model; and determining a new exploitation/exploration ratio and a new training iteration number.

In some embodiments, the exploitation/exploration ratio comprises an exploitation value and an exploration value and the exploitation value and the exploration value sum to one.

In some embodiments, the exploitation and the exploration value oscillate between zero and one.

In a broad aspect of the present disclosure, a system comprises: one or more devices comprising one or more circuits and memory for: receiving and transmitting one or more training models, performing training on the one or more training models using an exploitation/exploration ratio, and storing and updating a peak model; one or more aggregating devices comprising one or more circuits and memory for: receiving and transmitting the one or more training models, receiving and transmitting one or more trained models, and performing averaging and distilling of the one or more trained models.

In some embodiments, the system further comprises one or more orchestrating devices for: transmitting a set of training parameters comprising a current training iteration number and the exploitation/exploration ratio; receiving an iteration complete signal; and determining and transmitting a new exploitation/exploration ratio and new iteration number.

In some embodiments, the system is for 5G or 6G networking.

In some embodiments, the one or more devices are type 1 processing service functions (PSFs); the one or more aggregating devices are type 2 PSFs; and the one or more orchestrating devices are processing services controllers.

In some embodiments, the one or more aggregating devices comprise public data.

In some embodiments, the one or more devices are type 1 PSFs; the one or more aggregating devices are type 1 PSFs; and the one or more orchestrating devices are processing services controllers.

In some embodiments, the system further comprises one or more routing devices.

In some embodiments, the one or more routing devices are type 2 PSFs.

### BRIEF DESCRIPTION OF THE DRAWINGS

For a more complete understanding of the disclosure, reference is made to the following description and accompanying drawings, in which:

FIG. 1 is a schematic diagram illustrating a communication system according to some embodiments of the present disclosure;

FIG. 2 is a schematic diagram illustrating a communication system according to some embodiments of the present disclosure;

FIG. 3 is a schematic diagram of an electronic device and a base station according to some embodiments of the present disclosure;

FIG. 4 is a schematic diagram of modules of an electronic device according to some embodiments of the present disclosure;

FIG. 5 is a schematic diagram illustrating a sequence for an exemplary FedAvg method;

FIG. 6 is a schematic diagram illustrating an exemplary sequence for a Mutual Knowledge Distillation method;

FIG. 7 is a schematic diagram of an exemplary Annealing Knowledge Distillation pipeline;

FIG. 8 is a graph illustrating an oscillating alpha parameter;

FIG. 9 is a schematic diagram of an exemplary sequence for mutual KD comprising an orchestrator according to some embodiments of the present disclosure;

FIG. 10 is a schematic diagram illustrating a transmitting and receiving procedure of an orchestrator according to some embodiments of the present disclosure;

FIG. 11 is a schematic diagram illustrating a transmitting and receiving procedure of a node or client according to some embodiments of the present disclosure;

FIG. 12 is a schematic diagram of an exemplary sequence for mutual KD according to some embodiments of the present disclosure;

FIG. 13 is a schematic diagram illustrating an exemplary system architecture according to some embodiments of the present disclosure;

FIG. 14 is a schematic diagram illustrating an exemplary system architecture wherein public data is stored on a processing service function according to some embodiments of the present disclosure;

FIG. 15 is a schematic diagram illustrating an exemplary system architecture wherein public data is not stored on a processing service function according to some embodiments of the present disclosure;

FIG. 16 is a schematic diagram illustrating an exemplary embodiment of a method in a 6G environment according to some embodiments of the present disclosure;

FIG. 17 is a flowchart of a method for a client of an embodiment of the present disclosure;

FIG. 18 is a flowchart of a method for an aggregator of an embodiment of the present disclosure; and

FIG. 19 is a flowchart of a method for an orchestrator of an embodiment of the present disclosure.

### DETAILED DESCRIPTION OF THE ILLUSTRATIVE EMBODIMENTS

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

The term “a” or “an” refers to one or more of that entity; for example, “a module” refers to one or more modules or at least one module. As such, the terms “a” (or “an”), “one or more” and “at least one” are used interchangeably herein. In addition, reference to an element or feature by the indefinite article “a” or “an” does not exclude the possibility that more than one of the elements or features are present, unless the context clearly requires that there is one and only one of the elements. Furthermore, reference to a feature in the plurality (e.g., modules), unless clearly intended, does not mean that the modules or methods disclosed herein must comprise a plurality.

The expression “and/or” refers to and encompasses any and all possible combinations of one or more of the associated listed items (e.g. one or the other, or both), as well as the lack of combinations when interrupted in the alternative (or).

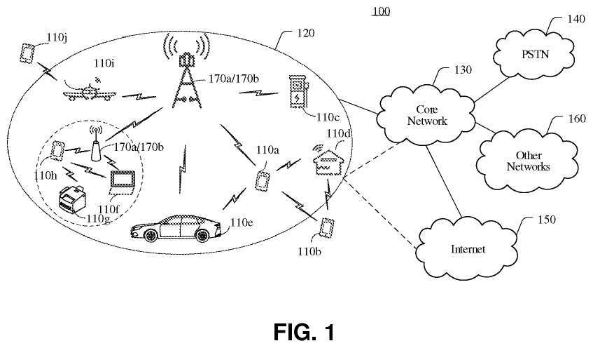

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

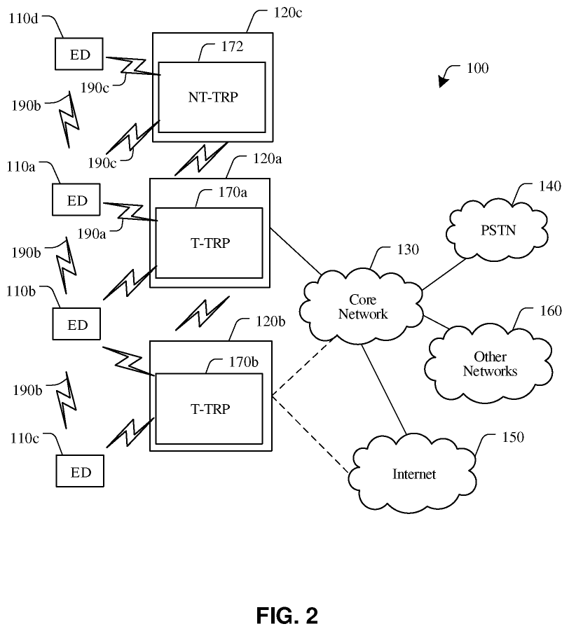

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

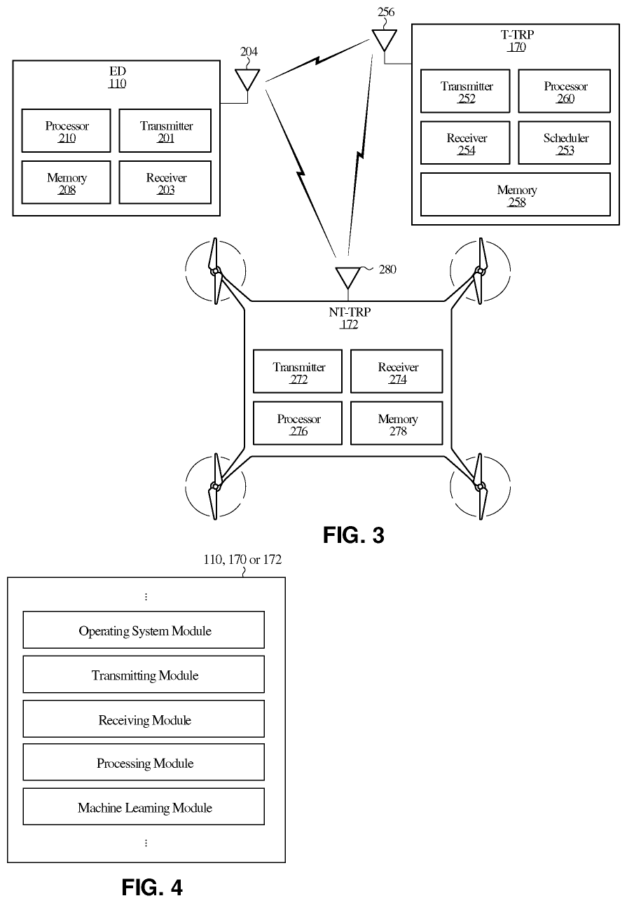

FIG. 3 illustrates another example of an ED 110 and a base station 170a, 170b and/or 170c. The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 4. FIG. 4 illustrates units or modules in a device, such as in the ED 110, in the T-TRP 170, or in the NT-TRP 172. For example, a signal may be transmitted or output by a transmitting unit or by a transmitting module. A signal may be received or input by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit include a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

While not shown, the transmitting module and the receiving module may be part of, or combined into, a transceiver module. A transceiver module may also be known as an interface module, or simply an interface, for inputting and outputting operations.

Additional details regarding the EDs 110, the T-TRP 170, and the NT-TRP 172 are known to those of skill in the art. As such, these details are omitted here.

Federated Learning (FL) is a method wherein global knowledge is learned from a network of clients without sharing their private data. Federated Averaging (FedAvg) is a widely adopted FL approach that dissipates knowledge through a federation of devices by averaging model parameters. FedAvg collects models from all participating devices, then the parameters of all models are averaged generating a global model. Lastly, the global model is communicated back to the participating clients. Knowledge Distillation (KD) is a widely adopted FL approach that dissipates knowledge through federation of devices by using the predictions (model outputs).

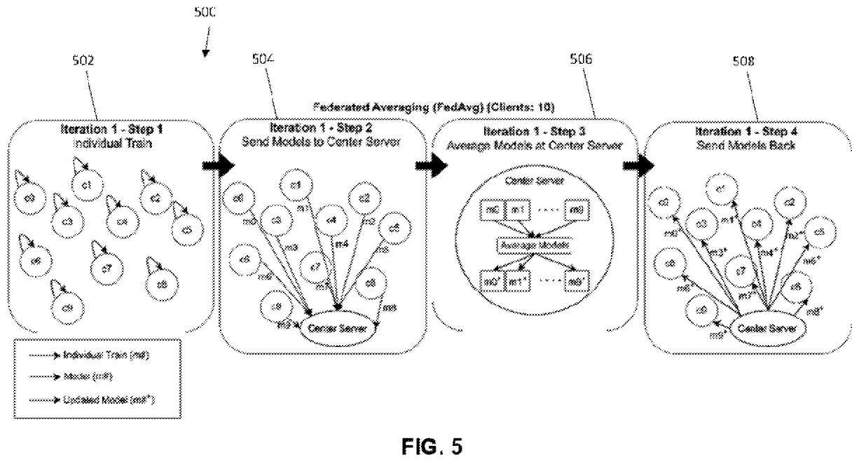

Decentralized Federated Learning (DFL) is a standard baseline approach for machine learning devices to learn from decentralized data. Learning from decentralized data contributes to preventing privacy leakage over centralized data. Two widely used federated learning aggregation techniques are weight-space aggregation and output-space aggregation. A disadvantage of weight-space aggregation methods are that models used therein must be homogeneous and a central server may be required. An example of weight-space aggregation is FedAvg. An additional downside of FedAvg is that its communication cost is high. Referring to FIG. 5, a sequence for a FedAvg method 500 is illustrated. In the first step 502 of FedAvg, participating clients are locally trained. In the second step 504, the locally trained models are communicated to the server. Next, in a third step 506, parameter averaging takes place. Lastly, in fourth step 508, the aggregated global model is communicated back to the participating clients.

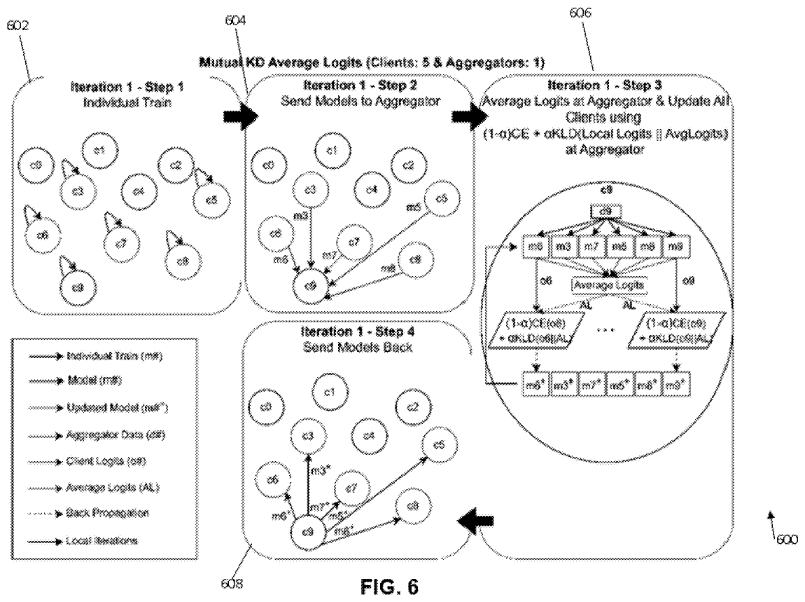

In contrast, output-space aggregation techniques such as knowledge distillation do not require a server and models may be heterogeneous. Mutual Knowledge Distillation (Mutual KD) is a method that uses knowledge distillation. Referring to FIG. 6, a sequence for a Mutual KD method 600 is illustrated. At the first step 602, randomly selected clients locally train their models. At the second step 604, the locally trained models are sent to a randomly selected aggregator. Next, at a third step 606, at the aggregator average logits is computed for knowledge distillation using Eq. 1 below. Finally, at a fourth step 608, after knowledge has been distilled, the updated models are sent back. The communication cost of Mutual KD is better than FedAvg as fewer clients are selected in each round.

L=(1−α)CE+αKLD (1)

Methods using output-space aggregation may be preferred over methods using weight-space aggregation due to support of different architectures and serverless design. However, convergence speed and accuracy performance of output-space aggregation methods may be inferior to weight-space aggregation methods.

In embodiments disclosed herein, methods provide serverless knowledge transfer between groups of nodes having different architectures with faster convergence and better final accuracy when compared to weight-space aggregation methods. Such methods may be advantageous for wireless networks, including 5G and 6G, because private data is better protected in mobile devices. Further, computing power of mobile devices having different architectures is better utilized, and knowledge is distributed effectively and efficiently across mobiles devices. This also provides improved AI processing using mobile devices.

Cross Entropy (CE) is used to measure the difference between two probability distributions. Kullback Leibler Divergence (KLD) a measure of dissimilarity using relative entropy between two probability distributions. Specifically, a measure of how much additional information is needed to encode events from one distribution based on another distribution.

In Mutual KD, the ratio between CE and KLD loss components is always fixed. As a result, cross entropy may be characterized as an exploitation stage and KD as an exploration stage. By using different fixed ratios throughout training between CE and KLD loss, neither convergence speed nor overall accuracy are enhanced. Conversely, fixing the ratio, a, to specific values may result in worse performance.

Weighted Soft-Labels (WSL) may be used to manage sample-wise bias-variance trade-off during distillation, as regularized samples leads to bias increasing and variance decreasing. This may be achieved by assigning a lower weight to regularization samples and a larger weight to others. The accuracy improvement may be minimal (<1%) and may result in unnoticeable enhancement in speed and accuracy. A scaling objective function may be as follows:

$${L}_{ws 1} = ( 1 - exp ( - \frac{log {\hat{y}}_{i , 1}^{s}}{log {\hat{y}}_{i , 1}^{t}} ) ) {L}_{kd} = ( 1 - exp ( - \frac{{L}_{ce}^{s}}{{L}_{ce}^{t}} ) ) {L}_{kd} ,$$

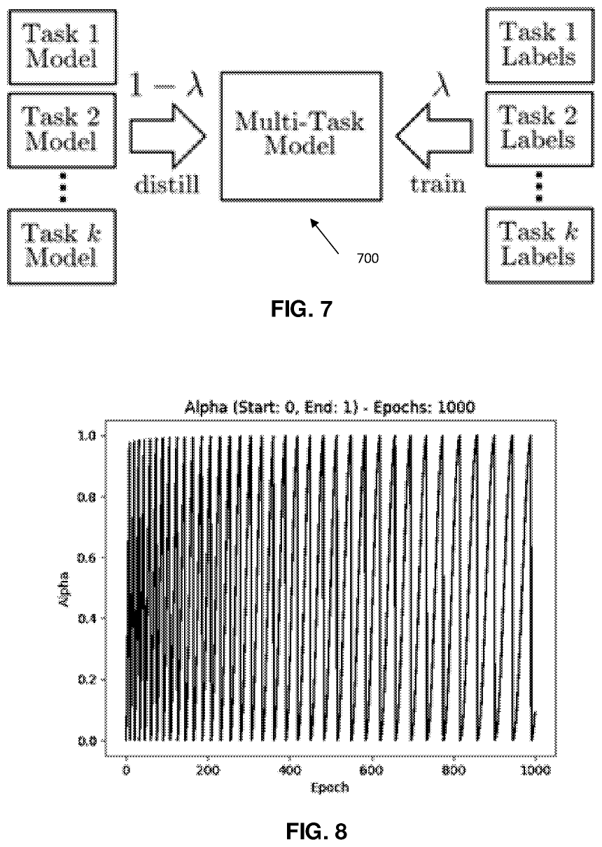

Annealing Knowledge Distillation (ANL-KD) is where a model is gradually transitioned from distillation to supervised learning. Early in training, the model is mostly distilling to get as much useful information from a training signal as possible. Towards the end of training, the model is mostly relying on the gold-standard labels so it can learn to surpass its teachers. λ is linearly increased from 0 to 1 throughout training. An ANL-KD sequence is illustrated in FIG. 7.

RW-KD is a sample-wise loss-weighting method that involves a meta-learner. Improvements of these weight scaling methods may result in marginal improvements in accuracy. A meta model is used to compute the weight taking a gradient step on the meta loss. Additionally, it has a complex implementation and thus not applicable on mobile devices.

Existing methods for Mutual KD do not operate in a decentralized federated learning environment that fully supports heterogeneous settings. Furthermore, the above described methods may not provide significant improvements in final accuracy and convergence speed, which is very important in mobile network applications.

In some embodiments disclosed herein, methods comprise an adaptive methodology for enhancing convergence speed which may be equivalent to reducing communication cost, and increasing final global accuracy. An adaptive KD method may comprise adapting the exploitation and exploration ratio represented by CE and KLD in knowledge distillation loss function. A method may be used to adapt the hyperparameter alpha (α) in the loss equation, allowing for different levels of exploration and exploitation across the distributed nodes during training. Function for oscillating α is shown in the below equation, and FIG. 8 shows an example oscillating alpha.

L=(1−α)CE+αKLD
α=f(current iteration, oscillation period)

In some embodiments of the present disclosure, each client will have two models being a regular model communicated throughout training, and a peak model which is stored locally in the client. The peak model comprises the best performing parameters. Each time alpha is high (that is, exploration is higher than exploitation), model performance is enhanced and a copy of the new model is saved as the peak model.

Some embodiments of the method disclosed herein are applicable in decentralized federated learning environments comprising a network of nodes that are capable of communicating. Each node may have the following functionalities: routing, communication, training and saving. Routing may include receiving a model from node i, and passing the received model to another node j. Communication may include receiving k models from different nodes, transmitting the updated models to the k nodes (after knowledge distillation), and communicating with an orchestrator. Training may include training a local model and the other k received models using knowledge distillation and local data. Saving may include saving a new, updated local model. An exemplary scenario is where a device is for understanding visual images stored thereon.

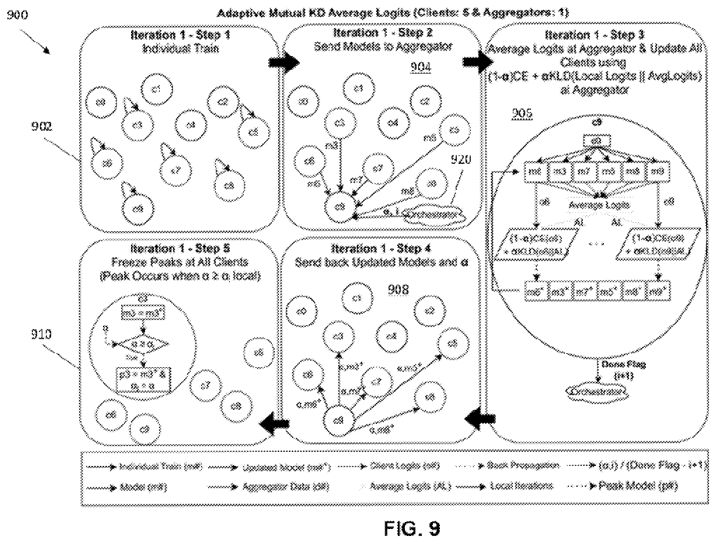

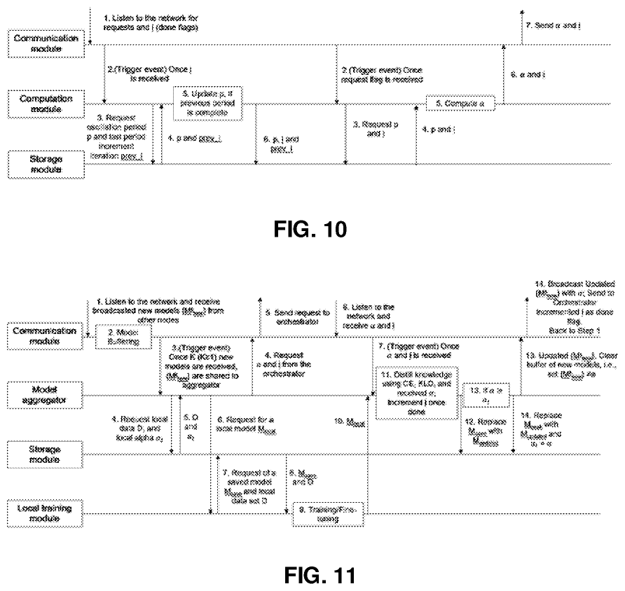

FIG. 9 illustrates a sequence 900 with adaptivity added to an embodiment of Mutual KD. At a first step 902, models are locally trained at local nodes c3, c5, c6, c7, c8 and c9. At a second step 904, trained models are sent to an aggregator c9. At a third step 906, after the locally trained models are sent to the aggregator c9, an orchestrator 920 communicates an alpha value and a current iteration number to the aggregator c9. At the aggregator c9, after average logits are determined, distillation takes place using the alpha sent from the orchestrator 920. When aggregation is complete, a done flag, represented by an increment of the iteration number, is sent to a server indicating that a new alpha should be computed and adjusts the locally saved iteration number with the incoming value. At a fourth step 908, the aggregator c9 sends the updated models and the current alpha value. At a fifth step 910, once models are back, each client will compare the incoming alpha with the locally saved alpha. If the incoming alpha is larger than or equal to the locally saved alpha then the peak model is updated with the incoming new model and the local model is replaced with the incoming model. In case the incoming alpha is smaller than the locally saved alpha then only the local model is updated. FIG. 10 illustrates a transmitting and receiving procedure of the orchestrator from the perspective of the application layer. FIG. 11 illustrates a transmitting and receiving procedure of a node or client from the perspective of the application layer.

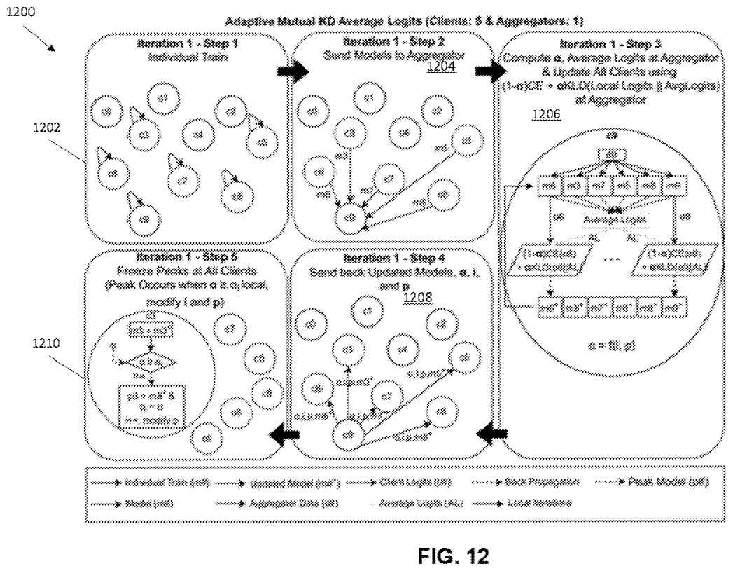

FIG. 12 illustrates a sequence 1200 with adaptivity added to an embodiment of Mutual KD without using an orchestrator. All local alphas are initialized to o, and the initial oscillation period is initialized. In the first round of model aggregation, the aggregator will compute the alpha based on the current iteration round. After aggregation is complete, the aggregator sends the alpha, the iteration number it was on, and the period it used. The next selected aggregator will use the locally stored info to compute a new alpha. The steps 1202, 1204, 1206, 1208 and 1210 are otherwise the same as the sequence comprising steps 902, 904, 906, 908 and 910 explained for FIG. 9.

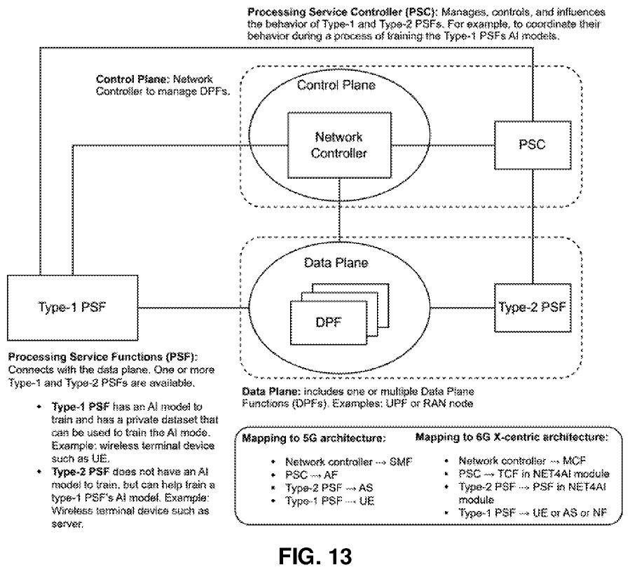

An exemplary system architecture for use in a 5G or 6G system is illustrated in FIG. 13. In such a system a goal is to transfer knowledge efficiently and effectively between Type-1 processing service function (PSF) AI models, while keeping each Type-1 data private.

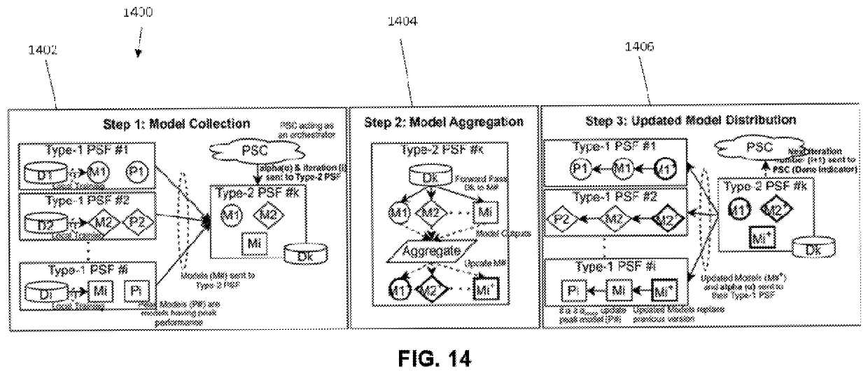

FIG. 14 illustrates an exemplary embodiment for a 6G networking system 1400 where Type-2 PSF comprises public data. At the first step 1402, after Type-1 PSF updates their models locally, they are transferred to Type-2 PSF. At Type-2 PSF, an alpha and iteration number is received from PSC which acts as an orchestrator. Next, at the second step 1404, Type-2 PSF will aggregate the knowledge using its local data and using the alpha received from a processing service controller (PSC). After aggregation, at the third step 1406, the models and the alpha are distributed back to their Type-1 PSFs. Additionally, Type-2 PSF may send a done indicator to the PSC informing it that its task is completed successfully. Finally, after the Type-1 PSF receives the updated models and the alpha value, they may replace their local model with the incoming model, and if the local stored alpha is less than the incoming alpha then the peak models are replaced with the incoming models.

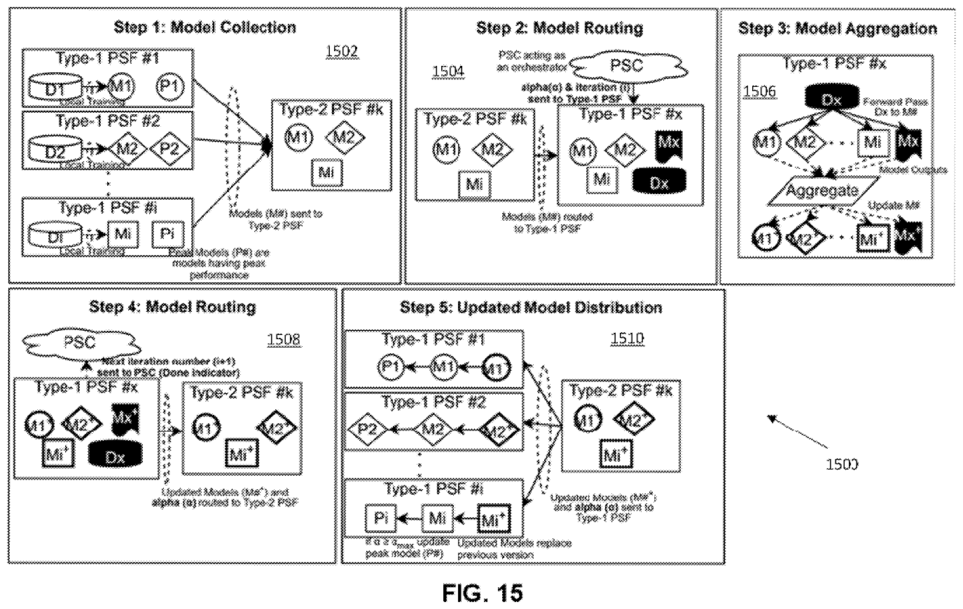

FIG. 15 illustrates an exemplary embodiment for 6G networking system 1500 where Type-2 PSF does not have public data. In this case, Type-2 PSF may act as a router of models. At the first step 1502, after Type-1 updates their models locally, they are transferred to Type-2 PSF. At the second step 1504, a Type-2 PSF forwards or routes their models to a Type-1 PSF. An alpha and iteration number is sent from PSC to the Type-1 PSF responsible for aggregation. Next, at the third step 1506, Type-1 PSF will aggregate the knowledge using its local data and using the alpha received from PSC. After aggregation, at the fourth step 1508 and the fifth step 1510, the models and the alpha are distributed or routed back to their Type-1 PSFs through Type-2 PSF. Additionally, Type-2 PSF will send a done indicator to the PSC informing it that its task is completed successfully. Finally, after the Type-1 PSF receives the updated models and the alpha value, they replace their local model with the incoming model, and if the local stored alpha is less than the incoming alpha then the peak models are replaced with the incoming models.

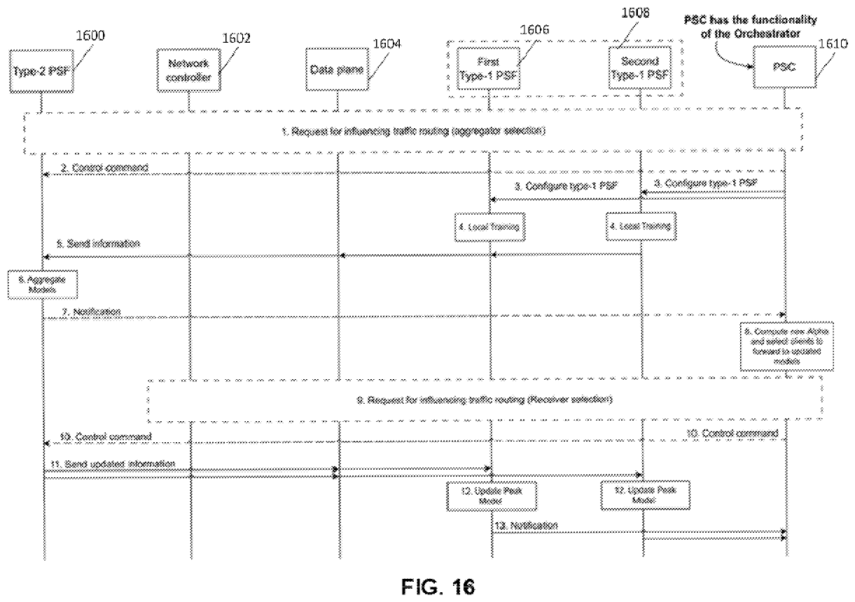

FIG. 16 is a flowchart illustrating a method for a 6G networking embodiment. At step 1, the PSC 1610 select leaders and clients based on data heterogeneity, model sizes, training/aggregation availability. Time windows may be defined for the leaders and clients to complete their assigned tasks. In this example, Type-1 PSFs 1606 and 1608 are selected as clients and the Type-2 PSF 1600 is selected as leader. The system may also comprise a network controller 1602 and a data plane 1604.

At step 2, the PSC 1610 sends control information to the leader. This may include the leader's identification address to allow connectivity with clients. This may also include the client's identification addresses to receive from models for aggregation and to send updated models. This may also include training configurations: alpha (α), aggregation iterations, temperature, optimizer learning rate, momentum, weight decay, loss function for training, etc. This may also include the current iteration number (i) and protocol agreements for handling errors in received models and lost information in the control packet. This may also include a defined time window to receive models from clients, and another window to finish the aggregation and forward updated information to clients and PSC 1610.

At step 3, the PSC 1610 sends configuration information to clients. This may include the clients' identification addresses to allow connectivity with the leader, as well as the leader's identification address for sending models and to receive updated models and alpha. This may also include local training configuration including number of iterations, optimizer, learning rate, momentum, weight decay and loss function. This may also include evaluation metrics to evaluate success level of local training. This may also include protocol agreements for handling errors due to lost information in a configuration packet, as well as a time window to finish local training and sending to the leader.

At step 4, each client may locally train its model using the configurations sent in step 3. The success of such training may be evaluated using a local test dataset.

At step 5, client models may be sent to the leader for aggregation. At step 6, the models may be aggregated at the leader using the configurations sent in step 2. At step 7, a notification may be sent to the PSC 1610 that aggregation has been successfully completed. The content of this notification may comprise the increment of the iteration number (i+1), wherein the iteration number (i) was sent to the leader in step 2.

At step 8, the PSC 1610 may check if the iteration number received, from the notification, is the increment of what was sent in step 2. Once this is verified, the PSC 1610 may compute a new alpha for the next aggregation round. If no notification is received in a defined time window, the PSC 1610 assumes that aggregator is not reachable (e.g. due to a topology change) and goes back to step 2, and selects a different leader.

At step 9, the PSC 1610 may select additional clients it should forward the updated models to (other than the clients that originally sent their models to). At step 10, a control command may be sent to the leader informing it about the new identification addresses it should forward the updated models to, which could be used at the next round of model aggregation. Also, new clients may be informed about the leader's identification address so that they can expect a model. Defined time window may also be propagated to the new clients for receiving the updated models.

At step 11, updated models may be sent with alpha (α) to the original clients and the clients selected in step 9. At step 12: original clients that sent their models for aggregation check whether a peak model has been obtained. Several peak models may be saved. This may be achieved by checking if the received alpha is larger than its local alpha (initially its value is set to 0). Further, a local alpha is updated to the received alpha.

At step 13: clients inform the PSC 1610 if an error occurred in the received updated information or time window has been surpassed.

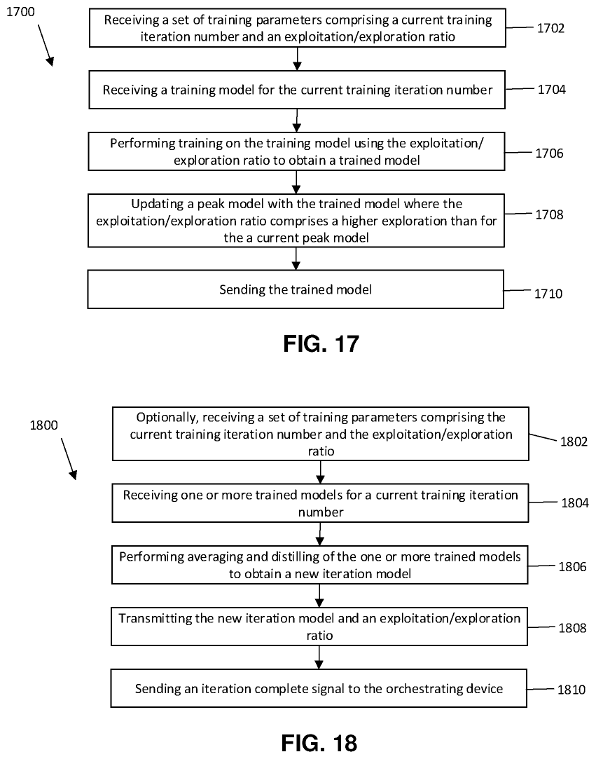

FIG. 17 is a flowchart showing steps of a method for a client 1700, according to one embodiment of the present disclosure. The method 1700 begins with receiving a set of training parameters comprising a current training iteration number and an exploitation/exploration ratio (step 1702). At step 1704, the method comprises receiving a training model for the current training iteration number. At step 1706, the method comprises performing training on the training model using the exploitation/exploration ratio to obtain a trained model. At step 1708, the method comprises Updating a peak model with the trained model based at least partly on the exploitation/exploration ratio comprising greater exploration than an exploitation/exploration ratio associated with a current peak model. At step 1710, the method comprises sending the trained model.

FIG. 18 is a flowchart showing steps of a method for an aggregator 1800, according to one embodiment of the present disclosure. The method 1800 begins with, optionally, receiving a set of training parameters comprising the current training iteration number and the exploitation/exploration ratio (step 1802). At step 1804, the method comprises receiving one or more trained models for a current training iteration number. At step 1806, the method comprises performing averaging and distilling of the one or more trained models to obtain a new iteration model. At step 1808, the method comprises transmitting the new iteration model and an exploitation/exploration ratio. At step 1810, the method comprises sending an iteration complete signal to the orchestrating device.

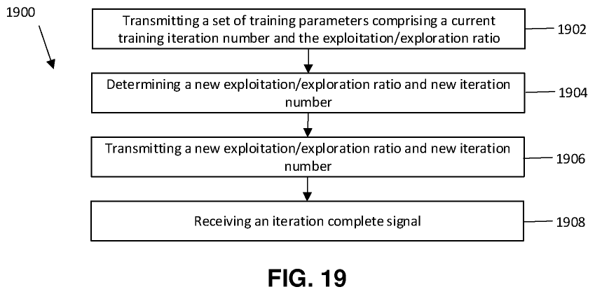

FIG. 19 is a flowchart showing steps of a method for an orchestrator 1900, according to one embodiment of the present disclosure. The method 1900 begins with transmitting a set of training parameters comprising a current training iteration number and the exploitation/exploration ratio (step 1902). At step 1904, the method comprises determining a new exploitation/exploration ratio and new iteration number. At step 1906, the method comprises transmitting a new exploitation/exploration ratio and new iteration number. At step 1908, the method comprises, optionally, receiving an iteration complete signal.

Although embodiments have been described above with reference to the accompanying drawings, those of skill in the art will appreciate that variations and modifications may be made without departing from the scope thereof as defined by the appended claims.

What is claimed is:

1. A method comprising:
receiving, by a device, a set of training parameters comprising a current training iteration number and an exploitation/exploration ratio;
receiving, by the device, a training model for the current training iteration number;
performing, by the device, training on the training model using the exploitation/exploration ratio to obtain a trained model;
updating, by the device, a current peak model with the trained model based at least partly on the exploitation/exploration ratio to obtain an updated peak model, wherein the exploitation/exploration ratio comprises greater exploration than another exploitation/exploration ratio associated with the current peak model; and
sending, by the device, the trained model.

2. The method of claim 1, wherein the exploitation/exploration ratio comprises an exploitation value and an exploration value, and wherein the exploitation value and the exploration value sum to one.

3. The method of claim 2, wherein the exploitation value and the exploration value oscillate between zero and one.

4. The method of claim 1, wherein the set of training parameters further comprises at least one of a temperature, an optimizer learning rate, a momentum, a weight decay, or a loss for training.

5. The method of claim 1, wherein the set of training parameters further comprises a time window for completing training for the current training iteration number.

6. A method comprising:
receiving, by an aggregating device, one or more trained models for a current training iteration number;
performing, by the aggregating device, averaging and distilling of the one or more trained models to obtain a new iteration model; and
transmitting, by the aggregating device, the new iteration model and an exploitation/exploration ratio.

7. The method of claim 6, further comprising receiving, by the aggregating device, a set of training parameters comprising the current training iteration number and the exploitation/exploration ratio.

8. The method of claim 7, wherein receiving the set of training parameters comprises receiving the set of training parameters from an orchestrating device.

9. The method of claim 8, further comprising sending, by the aggregating device, an iteration complete signal to the orchestrating device.

10. The method of claim 6, wherein the exploitation/exploration ratio comprises an exploitation value and an exploration value, and wherein the exploitation value and the exploration value sum to one.

11. The method of claim 10, wherein the exploitation value and the exploration value oscillate between zero and one.

12. The method of claim 7, wherein the set of training parameters further comprises at least one of a temperature, an optimizer learning rate, a momentum, a weight decay, or a loss for training.

13. The method of claim 7, wherein the set of training parameters further comprises a time window for completing training for the current training iteration number.

14. A system comprising:
one or more devices comprising one or more first circuits and one or more first memories, the one or more devices configured to:
receive and transmit one or more training models;
perform training on the one or more training models using an exploitation/exploration ratio; and
store and update a peak model; and
one or more aggregating devices comprising one or more second circuits and one or more second memories, the one or more aggregating devices configured to:
receive and transmit the one or more training models;
receive and transmit one or more trained models; and
perform averaging and distilling of the one or more trained models.

15. The system of claim 14, further comprising one or more orchestrating devices configured to:
transmit a set of training parameters comprising a current training iteration number and the exploitation/exploration ratio;
receive an iteration complete signal; and
determine and transmit a new exploitation/exploration ratio and a new training iteration number.

16. The system of claim 14, wherein:
the one or more devices comprise type 1 processing service functions (PSFs), and the one or more aggregating devices comprise type 2 PSFs.

17. The system of claim 14, wherein:
the one or more devices comprise first type 1 PSFs, and
the one or more aggregating devices comprise second type 1 PSFs.

18. The system of claim 15, wherein the one or more orchestrating devices comprise processing services controllers.

19. The system of claim 17, further comprising one or more routing devices.

20. The system of claim 19, wherein the one or more routing devices are type 2 PSFs.
